(19) United States
(12) Patent Application Publication
(10) Pub. No.: US 2019/0302261 A1
(43) Pub. Date: Oct. 3, 2019

(54) RANGE IMAGING CAMERA AND A METHOD THEREOF

(71) Applicant: NEWSIGHT IMAGING, Ness Ziona (IL)

(72) Inventor: David Leonardo Fleischer, Ness Ziona (IL)

(73) Assignee: NewSight Imaging Ltd., Ness Ziona, OT (IL)

(21) Appl. No.: 16/462,787

(22) PCT Filed: Nov. 28, 2017
(86) PCT No.: PCT/IL2017/051291

§ 371 Date: May 21, 2019

(51) Int. Cl. G01S 17/10; G01S 17/89; G01S 7/486; G01C 3/06; G01S 7/481

(52) U.S. Cl. CPC G01S 17/107; G01S 17/89; G01S 7/481; G01C 3/06; G01S 7/4865

(57) ABSTRACT

There is provided in accordance with an aspect of the presently disclosed subject matter a range imaging camera including a light source configured to emit a modulated light pulse towards an object; a shutter configured to modulate the portion of the light pulse with a modulation corresponding to the modulated light pulse; a detector having an array of photodiodes each of which being configured to detect a portion of the light pulse reflected from the object and transmitted through the shutter and to generate a signal, wherein the detector is configured to output a plurality of differential signals each of which being obtained by determining a difference between two signals generated by two adjacent photodiodes; and a controller configured for calculating distance between the light source and the object in accordance to the differential signals.

### FIELD OF INVENTION

The presently disclosed subject matter relates to Range Imaging Camera, in general, and in particular to a range imaging camera implementing a range gating technology.

### BACKGROUND

Range imaging camera systems are known for detecting distance based on the known speed of light, measuring the time-of-flight of a light signal between the camera and an object for each point of the image. The range imaging camera can be utilized in Light Detection and Ranging systems (LIDAR), scanning LIDAR or scannerless LIDAR systems.

Range gating technology, also known as time gating technology, utilizes a pulsed laser beam and a camera intensifiers that open and close at high speeds (once every few hundred nanoseconds). The camera intensifiers and the laser beam pulses are synchronized, such that the camera detects the portion of the laser beam reflected by the object modulated by the camera intensifiers.

FIG. 1 illustrates a prior art range imaging camera system 110 disclosed in U.S. Pat. No. 6,057,909 having a detector 112 with an array of photodiodes 114, and a camera intensifier 122 having a plurality of shutters 130, 132 etc. A modulated light beam is sent from a light source 40 towards an object 26 through a modulator 44, which forms short pulses of light. The reflected light travels via an optical lens 120 to the camera intensifier 122 which modulates the reflected light in the same manner as the light from the light source 40 is modulated by a modulator 44. The modulated reflected light then travels to detector 112 through an additional lens 124 where it is detected by photodiodes 114.

As a result, the range finding function is implemented with a fast shutter discriminating the pulse reflected from the object into a “front” section and a “back” section, as shown in FIG. 2. Such that the illuminated pulse 150 is radiated towards an object at a certain time with a certain pulse width, and the reflected pulse 152 arrives at the camera at a certain time delay dictated by the distance to the object. The shutter however allows the camera to capture light received within a time slot 154 corresponding to the width of the pulse 150 and at the same rate as the light pulses formed by the modulator. Thus, due to the time delay the camera detects only a front section of the reflected pulse 152.

In other words, a portion of every reflected pulse is blocked by the shutter, so that the amount of light received relates to the distance the pulse has traveled. The distance can be calculated using the equation,

$$D = \frac{1}{2} c {t}_{0} \frac{{S}_{2}}{{S}_{1} + {S}_{2}}$$

for an ideal camera. Where c is the speed of light; t₀ is the time the pulse takes to travel to the target and back; S₁ is the amount of the light pulse that is received; and S₂ is the amount of the light pulse that is blocked. i.e. the back portion of the pulse.

By measuring the light intensity in the discriminated pulse, the relative alignment of the reflected light can be ascertained. One challenge of this technique is that when accounting for the dynamic range of the light intensity being reflected, the sensor has to be provided with an extremely high level of sensitivity. Furthermore the measurement is typically carried out against a reference (i.e. a “dark” pixel), which also adds some variability.

According to an example, instead of using a mechanical shutter as described above, an electronic shutter can be utilized, the electronic shutter can be configured to readout the electrons accumulating in the photodiodes 114 at a predetermined time slot. i.e. if the light pulse 150 is a 50 nm pulse, the readout of the photodiodes 114 can be carried out at the end of the 50 nm time slot, synchronized with the light pulse 150. Due to the time of flight of the pulse, only a front section of the reflected pulse 152, reaches the photodiode 114, before the readout occurs. Accordingly, within the timeslot of the 50 nm pulse the photodiodes 114 read only a portion A of the reflected pulse 152. The above distance calculating equation requires however also the B component of the reflected pulse 152, i.e. the back portion of the light pulse which did not reach the photodiodes 114 during the 50 nm time slot. Thus, following the initial readout of the photodiodes 11 at the end of the 50 nm time slot, a second readout can be carried out after a predetermined time period, i.e. another 50 nm time slot. The second readout provides the data related to the back portion of the light pulse, i.e. the portion of the light which did not make it to the photodiodes 114 during the 50 nm time slot. This way, the two readouts provide both components of the reflected pulse 152 A and B, and the distance of the object can be calculated with the above equation.

### SUMMARY OF INVENTION

There is provided in accordance with an aspect of the presently disclosed subject matter a range imaging camera including a light source configured to emit a modulated light pulse towards an object; a shutter configured to modulate the portion of the light pulse with a modulation corresponding to the modulated light pulse; a detector having an array of photodiodes each of which being configured to detect a portion of the light pulse reflected from the object and transmitted through the shutter and to generate a signal, wherein the detector is configured to output a plurality of differential signals each of which being obtained by determining a difference between two signals generated by two adjacent photodiodes; and a controller configured for calculating distance between the light source and the object in accordance to the differential signals.

The photodiodes can include a plurality of first photodiodes and a plurality of second photodiodes, each of the second photodiodes is disposed adjacent one of the first photodiodes and wherein the differential signals are obtained by detecting a difference between a first signal from one of the first photodiodes and a second signal from one of the second photodiodes disposed in proximity to the first photodiode.

The second photodiodes can be disposed adjacent the first photodiode on the array.

The first photodiode can be configured to detect light reflected from a first section of the object, and the second photodiode can be configured to detect light reflected from a second section of the object being disposed adjacent the first section.

The first photodiode can include a first group of photodiodes and the second photodiode can include a second group of photodiodes, the first and second groups are disposed adjacent one another, and wherein first signal is generated from the first group and the second signal is generated from the second group.

Each one of the two signals can include an amplitude and wherein each one of the differential signals includes a differential amplitude determined by a difference between amplitudes of the two signals.

The pulse can include a front portion and a back portion and wherein the shutter is configured the back portion, wherein the size of the back portion, which is blocked by the shutter corresponds to the distance of the shutter from the object.

The apparatus can further include an amplifier configured to amplify the differential signals. The amplifier can include a plurality of differential amplifiers, each of which being coupled to a pair of photodiodes, and configured to output the differential signal.

The detector can be further configured to calculate a normalized sum of the two signals determining thereby an absolute distance of the object.

The detector can further include an electronic component configured to provide a signal representing the sum of all signals generated by the photodiodes. The electronic component can be configured to generate a common-mode signal and the detector can be further configured for reconstructing one of the signals generated by one or more of the photodiodes.

The differential signals can have a narrow dynamic range with respect to the dynamic range of all the signals generated by the array. The amplifier can be configured to amplify signal at a range corresponding to the narrow dynamic range.

There is provided in accordance with an aspect of the presently disclosed subject matter a method for computing a distance between a light source and an object. The method includes modulating a light pulse emitted from the light source; modulating a portion of the light pulse reflected by the object with a modulation corresponding to modulation of the light source; detecting the portion of the light pulse with an array of photodiodes; receiving at least one differential signal obtained by the difference between signals from the photodiodes; amplifying the differential signal and extracting a distance parameter from the object from the amplified differential signal.

The absolute distance of the objects can be calculated by means of the normalized sum of the first and second signals.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a prior art array range imaging camera system;

FIG. 2 is a graph illustration of the prior art light pulse detection; and

FIG. 3 is a schematic illustration of an electronic circuit coupled to a detector of a range imaging camera in accordance with an example of the presently disclosed subject matter.

### DETAILED DESCRIPTION OF EMBODIMENTS

The presently disclosed subject matter provides a range imaging camera having a detector which is configured to obtain a differential signal from photodiodes arranged in an array and disposed in proximity to one another thus enhancing the sensitivity of the camera.

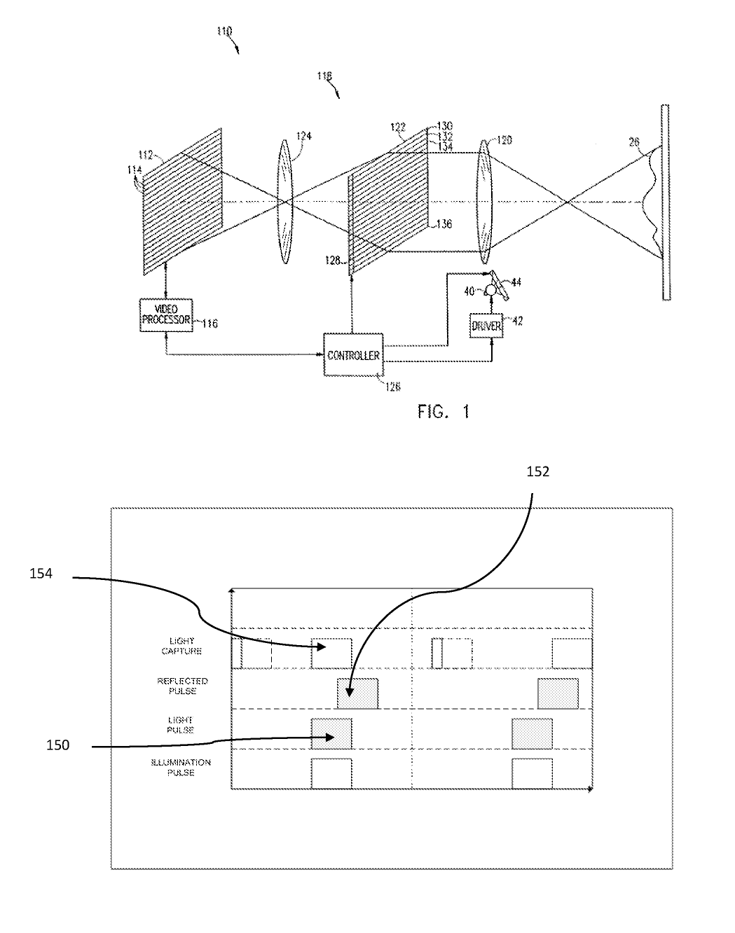

As described hereinabove with respect to FIG. 1, the range imaging camera can include a light source configured to emit a modulated light pulse towards an object. The light source can be a laser beam or other light source, and can be provided with a modulator such that the emitted light is emitted in predetermined pulses. The light source is configured to illuminate an object disposed at a distance from a camera.

The pulses are configured with a predetermined width and are provided in a predetermined frequency. The camera further includes a light detector configured to detect a portion of the light beam which is reflected from the object. In addition, the camera further includes a shutter which can be integrated within the detector. The shutter is configured to modulate the reflected light pulse with a modulation corresponding to the modulation of the light pulse emitted from the light source. That is to say, if the modulator is configured to modulate the light into pulses, the shutter is configured to open and close at the same rate as the width of the pulse. Thus, due to the time delay dictated by the distance between the camera and the object which reflects the light back to the detector, the camera detects only a front section of the reflected pulse. The rest of the light in the pulse, i.e. the back of the pulse is blocked by the shutter.

According to the present invention the detector includes an array of photodiodes configured to detect reflected light transmitted through the shutter. The photodiodes are arranged such that each pair of adjacent or close photodiodes is coupled to an electronic component which outputs a differential signal, i.e. a signal which is the difference between the signals generated by each of the photodiodes or groups of photodiodes. Since the detector includes a plurality of photodiodes, the photodiodes or groups of photodiodes are arranged in pairs, each of which providing a differential signal.

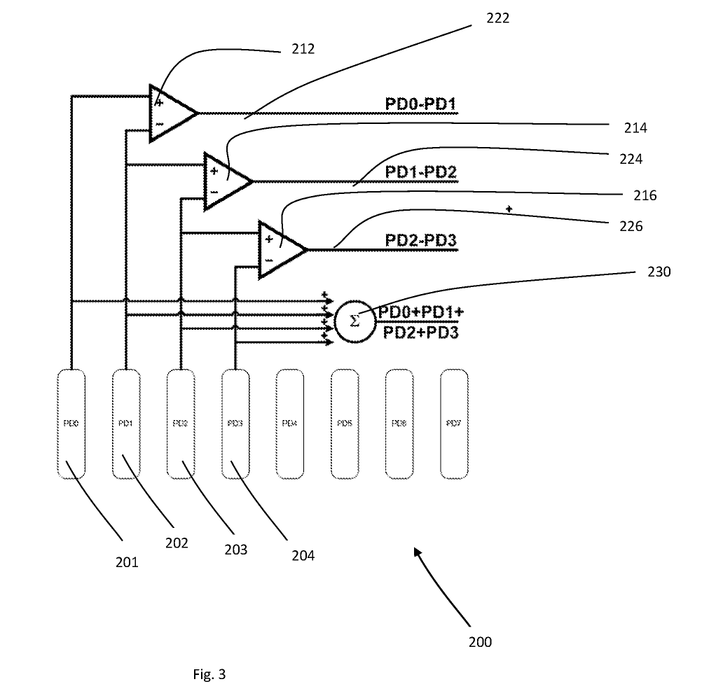

FIG. 3 shows an example of an electronic circuit 200 of a detector according to the present invention. The circuit 200 includes a plurality of photodiodes 201, 202, 203, etc. each of which having a conductor extended therefrom and configured to receive the charges generated by the respective photodiode. The circuit further includes a plurality of differential amplifiers 212, 214, 216, etc., each of which is coupled to a pair of photodiodes, and configured to output a differential signal. For example, the two input terminals of differential amplifier 212 are coupled to photodiodes 201 and 202 such that the output terminal thereof provides a differential signal of the pair of photodiodes 201 and 202. Similarly, the two input terminals of differential amplifier 214 are coupled to photodiodes 203 and 204 such that the output terminal thereof provides a differential signal of the pair of photodiodes 203 and 204.

Thus, the detector according to the present invention provides a plurality of analog differential signals 222, 224, 226 etc., representing the difference in the amount of light reflected from two adjacent or close points of the object, or points disposed in relative proximity to one another.

Circuit 200 comprises an electronic component 230 configured to provide a signal representing the sum of all the signals, i.e. a common-mode signal, the purpose of which is explained hereinafter.

The differential amplifiers 212, 214, 216 are further configured to amplify the differential signals 222, 224, 226. It will be appreciated that since the differential signals are obtained from photodiodes in relative proximity, it is expected that the amplitude of the differential signals is relatively low, and that the range of the amplitude of all the differential signals obtained by the detector is relatively small. This is due to the fact that in general adjacent or close photodiodes tend to detect light reflected from adjacent or close points of the object. That is to say, since the amount of light absorbed and/or scattered by these two points is similar, the difference in the amount of light reflected by these points is relatively small.

Accordingly, since the range of amplitudes of the differential signals 222, 224, 226 is small, the dynamic range of the amplifier can be configured in a relatively narrow range. This is in comparison with prior art detectors in which the amplifier has to amplify signals obtained from the photodiodes directly, i.e. signals with amplitudes varying from low amplitude, for points of the object which absorbs and/or scatters most of the light, to high amplitude, for points of the object which reflect most of the light towards the camera. Thus, the differential signals of the present invention have a narrow dynamic range suitable for being amplified to a signal with substantially improved signal to noise ratio.

The camera further includes a controller, such as an integrated CPU, configured for calculating distance between the light source and the object in accordance to the amplified differential signals. For example, the controller can be configured to digitize the values obtained by the differential signals and thereby determine the amount of light detected by each photodiode, in relation to the amount of light emitted by the light source. Thus, the distance of each point on the object from the camera can be obtained, for example by the equation

$$D = \frac{1}{2} c {t}_{0} \frac{{S}_{2}}{{S}_{1} + {S}_{2}} .$$

Where c is the speed of light; t₀ is the time the pulse takes to travel to the target and back; S₁ is the amount of the light pulse that is received; and S₂ is the amount of the light pulse that is blocked. i.e. the back portion of the pulse.

According to this example, since the detector detects the difference between the amplitudes of adjacent photodiodes or photodiodes disposed in relative proximity to one another, the calculation of distances provides the difference between the distance of a point of the object and neighboring points. In this manner, a precise 3D image of the object can be obtained.

According to an example of the presently disclosed subject matter the controller can be configured to further calculate the distance between the object and the camera, as opposed to only the differences between distances of adjacent or close points of the object.

This can be obtained by using the common-mode signal generated by electronic component 230 and reconstructing one of the signals generated by one or more of the photodiodes. The reconstructed signal allows calculating the distance of the object form the camera by comparing the amount of light received through the shutter with the amount of light emitted by the light source.

It is appreciated that owing to the “smooth” functions that characterize real objects, measuring the relative distance between different points on the same object will lead to the dynamic range of the reflected light to be less than the absolute measurement “almost everywhere”.

Therefore by measuring the reflected light from adjacent pixels against each other it is possible to substantially improve the depth resolution of the range-finding camera. Furthermore, the absolute depth of the objects in the entire scene can be reconstructed with simple methods such as normalization against the common mode signal for entire regions of the image.

Those skilled in the art to which the presently disclosed subject matter pertains will readily appreciate that numerous changes, variations, and modifications can be made without departing from the scope of the invention, mutatis mutandis.

1. A range imaging camera comprising:
a light source configured to emit a modulated light pulse towards an object;
a shutter configured to modulate said portion of said light pulse with a modulation corresponding to said modulated light pulse;
a detector having an array of photodiodes each of which being configured to detect a portion of said light pulse reflected from said object and transmitted through said shutter and to generate a signal, wherein said detector is configured to output a plurality of differential signals each of which being obtained by determining a difference between two signals generated by two adjacent photodiodes; and
a controller configured for calculating distance between the light source and said object in accordance to said differential signals.

2. The apparatus of claim 1, wherein said photodiodes includes a plurality of first photodiodes and a plurality of second photodiodes, each of said second photodiodes is disposed adjacent one of said first photodiodes and wherein said differential signals are obtained by detecting a difference between a first signal from one of said first photodiodes and a second signal from one of said second photodiodes disposed in proximity to said first photodiode.

3. The apparatus of claim 2, wherein said second photodiodes is disposed adjacent said first photodiode on said array.

4. The apparatus of claim 2, wherein said first photodiode is configured to detect light reflected from a first section of said object, and said second photodiode is configured to detect light reflected from a second section of said object being disposed adjacent said first section.

5. The apparatus of claim 2, wherein said first photodiode includes a first group of photodiodes and said second photodiode includes a second group of photodiodes, said first and second groups are disposed adjacent one another, and wherein first signal is generated from said first group and said second signal is generated from said second group.

6. The apparatus of claim 1, wherein each one of said two signals includes an amplitude and wherein each one of said differential signals includes a differential amplitude determined by a difference between amplitudes of said two signals.

7. The apparatus of claim 1 wherein said pulse includes a front portion and a back portion and wherein said shutter is configured said back portion, wherein the size of said back portion, which is blocked by said shutter corresponds to the distance of said shutter from said object.

8. The apparatus of claim 1 further comprising an amplifier configured to amplify said differential signals.

9. The apparatus of claim 8 wherein said amplifier includes a plurality of differential amplifiers, each of which being coupled to a pair of photodiodes, and configured to output said differential signal.

10. The apparatus of claim 1, wherein said detector is further configured to calculate a normalized sum of said two signals determining thereby an absolute distance of the object.

11. The apparatus of claim 1, wherein said detector further includes an electronic component configured to provide a signal representing the sum of all signals generated by said photodiodes.

12. The apparatus of claim 11 wherein said electronic component is configured to generate a common-mode signal and said detector is further configured for reconstructing one of the signals generated by one or more of said photodiodes.

13. The apparatus of claim 1, wherein said differential signals has a narrow dynamic range with respect to the dynamic range of all the signals generated by said array.

14. The apparatus of claim 13, wherein said amplifier is configured to amplify signal at a range corresponding to said narrow dynamic range.

15. A method for computing a distance between a light source and an object, the method comprising:
modulating a light pulse emitted from said light source;
modulating a portion of said light pulse reflected by the object with a modulation corresponding to modulation of said light source;
detecting said portion of said light pulse with an array of photodiodes;
receiving at least one differential signal obtained by the difference between signals from said photodiodes;
amplifying said differential signal and extracting a distance parameter from the object from said amplified differential signal.

16. The method according to claim 15, wherein the absolute distance of the objects is further calculated by means of the normalized sum of said first and second signals.
